(19) United States
(12) Patent Application Publication
(10) Pub. No.: US 2024/0221596 A1
(43) Pub. Date: Jul. 4, 2024

(54) DISPLAY DEVICE AND DRIVING METHOD THEREOF

(71) Applicant: LG Display Co., Ltd., Seoul (KR)

(72) Inventor: Youngho KIM, Paju-si (KR)

(21) Appl. No.: 18/499,729

(22) Filed: Nov. 1, 2023

(30) Foreign Application Priority Data
Dec. 28, 2022 (KR) 10-2022-0187620

(51) Int. Cl. G09G 3/20; G09G 3/3233

(52) U.S. Cl. CPC G09G 3/2096; G09G 3/3233; G09G 2300/0819; G09G 2300/0842; G09G 2310/08; G09G 2320/0233; G09G 2320/045

(57) ABSTRACT

The embodiments relate to display devices and driving methods thereof. A display device includes a display panel including sub-pixels arranged thereon, a gate driver configured to applying a scan signal to the sub-pixels, and a controller configured to sense a characteristic value of the sub-pixels, wherein the controller outputs a first clock and a second clock based on a count value increasing sequentially from an initial value during a sensing period for sensing selected sub-pixels, the gate driver generates a gate clock signal in synchronization with the first clock and the second clock and the scan signal based on the gate clock signal.

### CROSS REFERENCE TO RELATED APPLICATION

The present application claims priority to Korean Patent Application No. 10-2022-0187620, filed on Dec. 28, 2022, the entire contents of which is incorporated herein for all purposes by this reference.

### BACKGROUND

### Technical Field

The present disclosure relates to display devices driving methods thereof.

### Description of the Related Art

With the advancement of the information society, there is an increasing demand for display devices that can show images, and various types of display devices such as liquid crystal display (LCD) devices and organic light-emitting diode (OLED) displays are being utilized.

The driving transistors equipped on the pixels of a display device have characteristic values such as threshold voltage and mobility, and as the driving time increases, the pixels degrade, resulting in changes to the characteristic values. To compensate for the changes in characteristic values, a compensation method can be applied to a display device by operating the display device in a sensing drive mode to sense the characteristic values of the pixels and compensate data to be applied to the pixels based on the sensed values.

Recently, the higher resolution of display devices has led to an increase in the number of pixels, which in turn has posed a problem of longer compensation time.

### BRIEF SUMMARY

Embodiments provide display devices and driving methods thereof that are capable of reducing the time required for pixel sensing.

Embodiments provide display devices and driving methods thereof that are capable of reducing the power-on sensing time, thereby decreasing the user response time until the image is displayed.

A display device according to an embodiment includes a display panel including sub-pixels arranged thereon, a gate driver configured to applying a scan signal to the sub-pixels, and a controller configured to sense a characteristic value of the sub-pixels, wherein the controller output may a first clock and a second clock based on a count value increasing sequentially from an initial value during a sensing period for sensing selected sub-pixels, and the gate driver may generate a gate clock signal in synchronization with the first clock and the second clock and generate the scan signal based on the gate cluck signal.

The controller may output the first clock in response to the count value reaching a first reference count value and the second clock in response to the count value reaching a second reference count.

The gate clock signal may be synchronized at the rising edge thereof with the rising edge time of the first clock and at the falling edge thereof with the falling edge of the second clock.

The controller may sense the sub-pixels sequentially in units of a pixel line and in units of color on the same pixel line.

The controller may determine initialization of the count value based on whether the selected sub-pixels are on the same pixel line as the previously sensed sub-pixels.

The controller may set the initial value of the count value to the first reference count value in response to the selected sub-pixels being on the same pixel line as the previously sensed sub-pixels.

The controller may initialize the count value in response to the selected sub-pixels being not on the same pixel line as the previously sensed sub-pixels.

The controller may include a memory configured to store information on the pixel line of the selected sub pixels.

The controller may transmit a sensing start signal to the gate driver, and the gate driver output the gate clock signal in response to the sensing start signal.

The controller may sense the characteristic value of the sub-pixels in response to generation of a power-on signal.

A driving method of a display device including a display panel on which sub-pixels are arranged, a gate driver applying a scan signal to the sub-pixels, and a controller sensing a characteristic value of the sub-pixels, according to an embodiment, may include increasing, by the controller, a count value from an initial value during a sensing period for sensing predetermined selected sub-pixels, outputting a first clock in response to the count value reaching a first reference count value, outputting a second clock in response to the count value reaching a second reference count value, and generating, by the gate driver, a gate clock signal in synchronization with the first clock and the second clock.

The method may further include determining, before the increasing of the count value, whether the selected sub-pixels are on the same pixel line as the previously sensed sub-pixels, and setting the initial value of the count value to the first reference count value in response to the selected sub-pixels being on the same pixel line as the previously sensed sub-pixels.

The method may further include initializing the count value in response to the selected sub-pixels being not on the same pixel line as the previously sensed sub-pixels.

The method may further include storing information on the pixel line of the selected sub-pixels.

The sensing of the characteristic value of the sub-pixels may be performed in response to generation of a power-on signal.

### BRIEF DESCRIPTION OF THE SEVERAL VIEWS OF THE DRAWINGS

FIG. 1 is a block diagram illustrating a display device according to an embodiment;

FIG. 2 is a circuit diagram illustrating a pixel depicted in FIG. 1 according to an embodiment;

FIG. 3 is a diagram illustrating a compensation circuit according to an embodiment;

FIG. 4 is a diagram for explaining a method for sensing a threshold voltage of a

driving transistor according to an embodiment;

FIG. 5 is a diagram for explaining a method for sensing mobility of a driving transistor;

FIG. 6 is a diagram illustrating a sensing timing;

FIG. 7 is a block diagram illustrating a connection relationship between a controller

and a gate driver;

FIG. 8 is a timing diagram illustrating transmission and reception signals between a controller and a gate driver during an on-sensing process according to an embodiment; and

FIG. 9 is a timing diagram illustrating transmission and reception signals between a controller and a gate driver during an on-sensing process according to another embodiment.

### DETAILED DESCRIPTION

Hereinafter, embodiments will be described with reference to accompanying drawings. In the specification, when a component (or area, layer, part, etc.) is mentioned as being “on top of,” “connected to,” or “coupled to” another component, it means that it may be directly connected/coupled to the other component, or a third component may be placed between them.

The same reference numerals refer to the same components. In addition, in the drawings, the thickness, proportions, and dimensions of the components are exaggerated for effective description of the technical content. The expression “and/or” is taken to include one or more combinations that can be defined by associated components.

The terms “first,” “second,” etc., are used to describe various components, but the components should not be limited by these terms. The terms are used only for distinguishing one component from another component. For example, a first component may be referred to as a second component and, similarly, the second component may be referred to as the first component, without departing from the scope of the present disclosure. As used herein, the singular forms are intended to include the plural forms as well, unless the context clearly indicates otherwise.

The terms such as “below,” “lower,” “above.” “upper,” etc., are used to describe the relationship of components depicted in the drawings. The terms are relative concepts and are described based on the direction indicated on the drawing.

It will be further understood that the terms “comprises,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

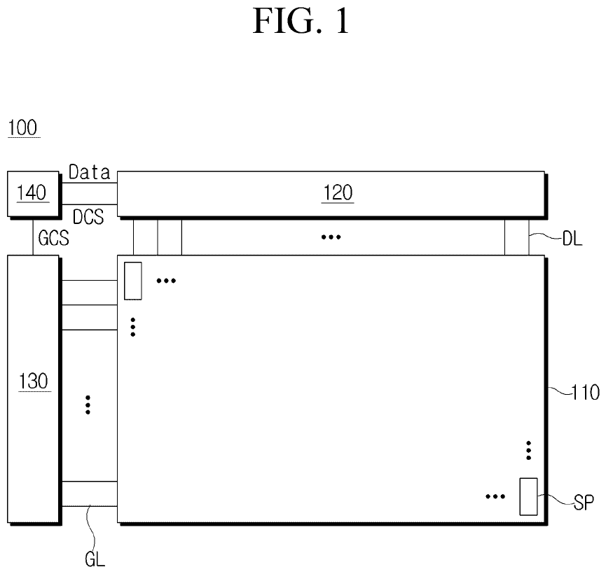

FIG. 1 is a block diagram illustrating a display device according to an embodiment.

With reference to FIG. 1, a display device 100 according to the embodiments includes display panel 110 comprised of a plurality of data lines DL and a plurality of gate lines GL arranged thereon that are connected to a plurality of sub-pixels SP arrayed thereon, a data driver 120 for driving a plurality of data lines DL, a gate driver 130 for driving a plurality of gate lines GL, and a controller 140 for controlling the data driver 120 and the gate driver 130.

The controller 140 receives various timing signals, including a vertical sync signal, a horizontal sync signal, an input data enable signal, and a clock signal, along with input video data from an external source (e.g., host system). Based on these timing signals, the controller 140 generates various control signals to output to the data driver 120 and gate driver 130. The controller 140 supplies various control signals to the data driver 120 and gate driver 130 to control the data driver 120 and gate driver 130.

For example, the controller 140 outputs various gate control signals GCS, including gate start pulse, gate clock, and gate output enable signals to control the gate driver 130. Similarly, the controller 140 outputs various data control signals DCS, including source start pulse, source sampling clock, and source output enable signals, to control the data driver 120.

The controller 140 initiates scanning based on the timing implemented in each frame and converts the input video data received from external sources to the data signal format used by the data driver 120 to output the converted video data (Data).

The controller 140 may be a timing controller commonly used in display technology or a control device that includes a timing controller along with additional control functions. The controller 140 may be implemented as a separate component from the data driver 120 or integrated circuitry together with the data driver 120.

The data driver 120 generates data voltages based on the data control signals DCS and drives the plurality of data lines DL by supplying the data voltages to the data lines DL. The data driver 120 may include at least one source driver integrated circuit.

Each source driver integrated circuit may include a shift register, a latch circuit, a digital-to-analog converter (DAC), and an output buffer. In some cases, an analog-to-digital converter (ADC) may also be included in each source driver integrated circuit.

The gate driver 130 may generate scan signals based on the gate control signals GCS. The scan signal may be a pulse signal having a turn-on level during one horizontal period (1H). The gate driver 130 sequentially drives the plurality of gate lines GL by supplying the scan signal to them.

The gate driver 130 may include at least one gate driver integrated circuit GDIC. Each gate driver integrated circuit GDIC may include a shift register and a level shifter. Under the control of the controller 140, the gate driver 130 may sequentially supply on-scan signals at an on-scan level or off-scan level to the plurality of gate lines GL.

The data driver 120 converts the video data received from the controller 140 into analog data voltages and supply the converted data voltages to the plurality of data lines DL for one horizontal period (1H) when a certain pixel row is scanned by the gate driver 130. That is, the 1H period represents the time during which the data voltages are applied to the sub-pixels SP sharing a single gate line GL.

Each sub-pixel SP arranged on the display panel 110 is composed of circuit components such as an organic light-emitting diode OLED as a self-emissive device and driving transistors used for driving the OLED. The types and quantities of circuit components constituting each sub-pixel SP may vary depending on the desired functionalities and design approaches.

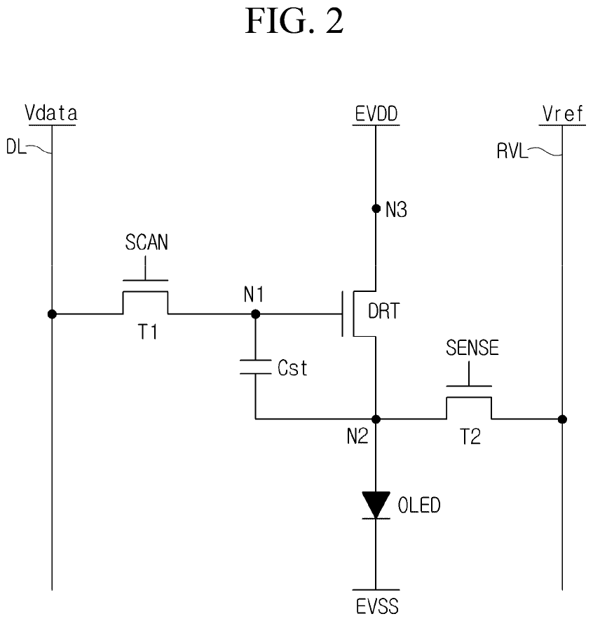

FIG. 2 is a circuit diagram illustrating a sub-pixel shown in FIG. 1.

With reference to FIG. 2, a sub-pixel SP may be composed of an organic light-emitting diode OLED, a driving transistor DRT for driving the OLED, a first transistor T1 for delivering data voltage to the first node N1 connected to the gate electrode of the driving transistor DRT, and a storage capacitor Cst to maintain the data voltage corresponding to a video signal voltage or the corresponding voltage during one frame period.

The organic light-emitting diode OLED may include a first electrode (e.g., anode electrode or cathode electrode), an organic layer, and a second electrode (e.g., cathode electrode or anode electrode). The second electrode of the organic light-emitting diode OLED may be supplied with a base voltage EVSS.

The driving transistor DRT drives the organic light-emitting diode OLED by supplying driving current to the organic light-emitting diode OLED. The gate electrode of the driving transistor DRT may be electrically connected to the first node N1. One electrode of the driving transistor DRT may be electrically connected to the second node N2, i.e., the first electrode of the organic light-emitting diode OLED, and it may be either the source electrode or the drain electrode. The other electrode of the driving transistor DRT may be connected to the third node N3, i.e., a node to which the driving voltage EVDD is applied, and it may be either the drain electrode or the source electrode.

The first transistor T1 is electrically connected between the data line DL and the first node N1 and receives the scan signal SCAN at the gate electrode thereof. The first transistor T1 may be turned on by the scan signal SCAN and transfer the data voltage Vdata supplied through the data line DL to the first node N1.

The storage capacitor Cst may be electrically connected between the first node N1 and the second node N2 of the driving transistor DRT.

As the drive time of the sub-pixel SP increases, the circuit components such as the organic light-emitting diode OLED and the driving transistor DRT may degrade. Accordingly, the circuit components such as the organic light-emitting diode OLED and the driving transistor DRT may undergo changes in their inherent characteristic values. Here, the characteristic values may include the threshold voltage of the organic light-emitting diode OLED, the threshold voltage of the driving transistor DRT, and the mobility of the driving transistor DRT, among others.

Changes in the characteristic values of circuit components may lead to variations in the luminance of the corresponding sub-pixel PX. Furthermore, the extent of change in characteristic values between circuit components may vary depending on the degradation degree of the sub-pixel PX. Differences in characteristic values may result in luminance deviations among pixels.

To address these issues, the sub-pixel SP according to an embodiment may include a compensation circuit for detecting characteristic values of the sub-pixel SP and compensating for characteristic value changes.

With reference to FIG. 2, the sub-pixel SP may include a second transistor T2. The second transistor T2 is electrically connected between the second node N2 and a reference voltage line RVL supplying a reference voltage Vref and may be controlled by a sensing signal SENSE, which is a type of scan signal, applied to the gate node thereof. The second transistor T2 turns on in response to the sensing signal SENSE and applies the reference voltage Vref, supplied through the reference voltage line RVL, to the second node N2. The second transistor T2 may also serve as one of the voltage sensing paths for the driving transistor DRT.

In an embodiment, the scan signal SCAN and the sensing signal SENSE may be separate scan signals. In this case, the scan signal SCAN and the sensing signal SENSE may be applied to the gate nodes of the first transistor T1 and the second transistor T2, respectively, through different gate lines.

In another embodiment, the scan signal SCAN and the sensing signal SENSE may be the same gate signal. In this case, the scan signal SCAN and the sensing signal SENSE may be commonly applied to the gate nodes of both the first transistor T1 and the second transistor T2 through the same gate line.

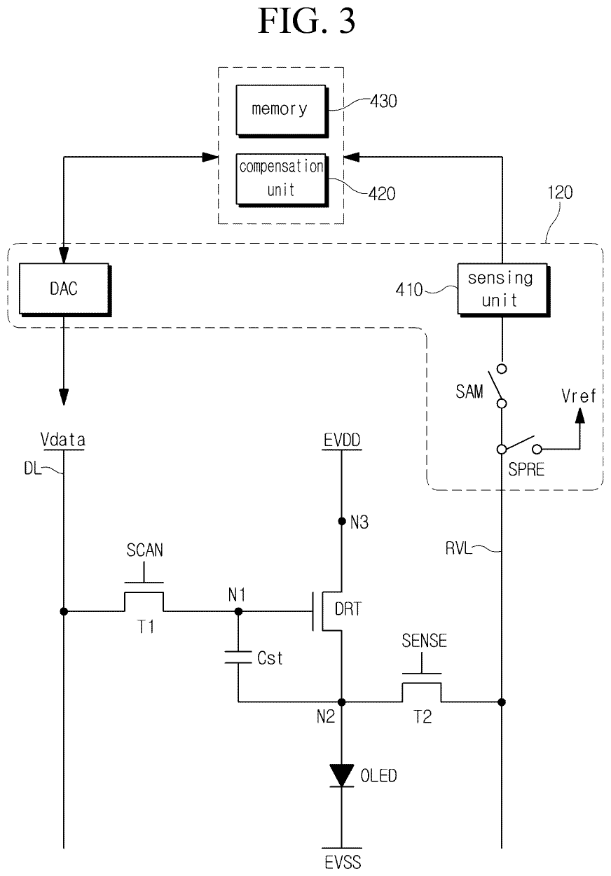

FIG. 3 is a diagram illustrating a compensation circuit according to an embodiment.

With reference to FIG. 3, the display device 100 may include a sensing unit 410 that generates sensing data by sensing the voltage of sub-pixel SP and outputs the sensing data, a compensation unit 420 that determines the characteristic values of the sub-pixel SP based on the sensing data and performs a compensation process to compensate for the characteristic values, and a memory 430 that stores the initially preset compensation data (or initial compensation values) and the compensation values generated by the compensation unit 420.

The sensing unit 410 may be implemented to include at least one analog-to-digital converter. This sensing unit 410 may be arranged inside the data drivee 120 as depicted or outside. The sensing data output from the sensing unit 410 may have a low voltage differential signaling (LVDS) data format.

The compensation unit 420 and the memory 430 may be arranged inside or outside the timing control unit 140. The memory 430 may store the sensing data applied thereto and transmit the stored sensing data to the compensation unit 420. In another embodiment, the compensation unit 420 may directly receive the sensing data, compute the compensation value, and store the compensation value and sensing data in the memory 430.

The memory 430 may store preset initial compensation data and the sensing data received from the sensing unit 410 or the compensation value computed by the compensation unit 420.

The display device 100 may include an initialization switch SPRE for controlling the on/off state of the reference voltage line RVL and a sampling switch SAM for controlling the connection between the reference voltage line RVL and the sensing unit 410.

The initialization switch SPRE may control the voltage application state of the second node N2 in the sub-pixel SP to achieve the desired characteristic values of the circuit components. When the initialization switch SPRE is turned on, the reference voltage Vref may be supplied to the reference voltage line RVL and applied to the second node N2 through the turned-on second transistor T2.

When turned on, the sampling switch SAM may electrically connect the reference voltage line RVL and the sensing unit 410. The sampling switch SAM may be controlled to turn on when the voltage state at the second node N2 in the sub-pixel SP reflects the desired characteristic values of the circuit components. When the sampling switch SAM is turned on, the sensing unit 410 may sense the voltage of the connected reference voltage line RVL.

When the sensing unit 410 senses the voltage of the reference voltage line RVL, if the second transistor T2 is turned on and the resistive component of the driving transistor DRT can be ignored, the voltage sensed by the sensing unit 410 may correspond to the voltage at the second node N2. The voltage sensed by the sensing unit 410 may be the voltage of the reference voltage line RVL, i.e., the voltage at the second node N2.

When there is a line capacitor on the reference voltage line RVL, the voltage sensed by the sensing unit 410 may be the voltage charged on the line capacitor on the reference voltage line RVL. For example, the voltage sensed by the sensing unit 410 may be the voltage value including the threshold voltage Vth or threshold voltage deviation ΔVth of the driving transistor DRT (Vdata-Vth or Vdata-ΔVth, where Vdata is the data voltage for sensing drive) or the voltage value used to sense the mobility of the driving transistor DRT.

Meanwhile, the reference voltage line RVL may be arranged per column of sub-pixels or per two or more columns of sub-pixels. For example, when a single pixel consists of four sub-pixels (red, white, green, and blue sub-pixels), the reference voltage lines RVL may be arranged per four columns of sub-pixels (red sub-pixel column, white sub-pixel column, green sub-pixel column, blue sub-pixel column) and connected in common to the four sub-pixel columns.

Hereinafter, descriptions are made of the threshold voltage sensing operation and mobility sensing operation for the driving transistor DRT briefly.

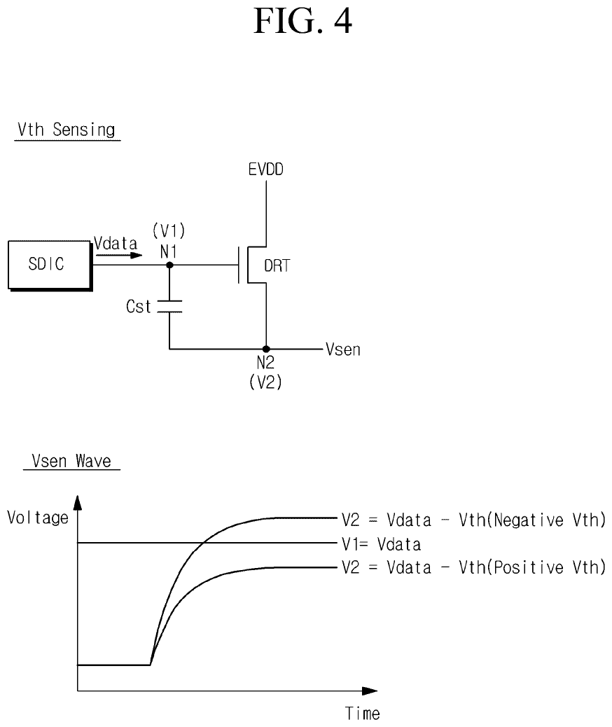

FIG. 4 is a diagram for explaining a threshold voltage sensing method for a driving transistor according to an embodiment.

With reference to FIGS. 3 and 4, the threshold voltage sensing operation for the driving transistor DRT may be performed through a sensing process including an initialization stage, a tracking stage, and a sampling stage.

The initialization stage involves initializing the first node N1 and the second node N2. In the initialization stage, the initialization switch SPRE is turned on. Subsequently, the scan signal SCAN and the sensing signal SENSE is applied to turn on the first transistor T1 and the second transistor T2. As a result, the first node N1 and the second node N2 are respectively initialized with the data voltage Vdata for threshold voltage sensing operation and the reference voltage Vref (V1=Vdata, V2=Vref).

The tracking stage involves changing the voltage V2 of the second node N2 until it reaches a voltage state reflecting the threshold voltage or change in the threshold voltage. That is, the tracking stage is the process of tracking the voltage of the second node N2 that reflects the threshold voltage or change in the threshold voltage. During the tracking stage, the initialization switch SPRE or the second transistor T2 may be turned off, causing the second node N2 to float. As a result, the voltage V2 of the second node N2 increases.

The voltage V2 of the second node N2 increases while the rate of increase decreases until it reaches saturation. The saturated voltage of the second node N2 may correspond to the difference between the data voltage Vdata and the threshold voltage Vth or the difference between the data voltage Vdata and the threshold voltage deviation ΔVth.

Once the voltage V2 of the second node N2 saturates, the sampling stage may proceed. The sampling stage involves measuring the voltage reflecting the threshold voltage or the change in the threshold voltage of the driving transistor DRT, and in this stage the sensing unit 410 senses the voltage of the reference voltage line RVL, i.e., the voltage of the second node N2. During the sampling stage, the sampling switch SAM may be turned on, establishing a connection between the sensing unit 410 and the reference voltage line RVL, allowing the sensing unit 410 to sense the voltage of the reference line RVL, i.e., the voltage V2 of the second node N2.

The sensed voltage Vsen sensed by the sensing unit 410 may be the difference between the data voltage Vdata and the threshold voltage Vth (Vdata-Vth) or the difference between the data voltage Vdata and the threshold voltage variation ΔVth (Vdata-ΔVth). Here, Vth may refer to a positive threshold voltage or a negative threshold voltage.

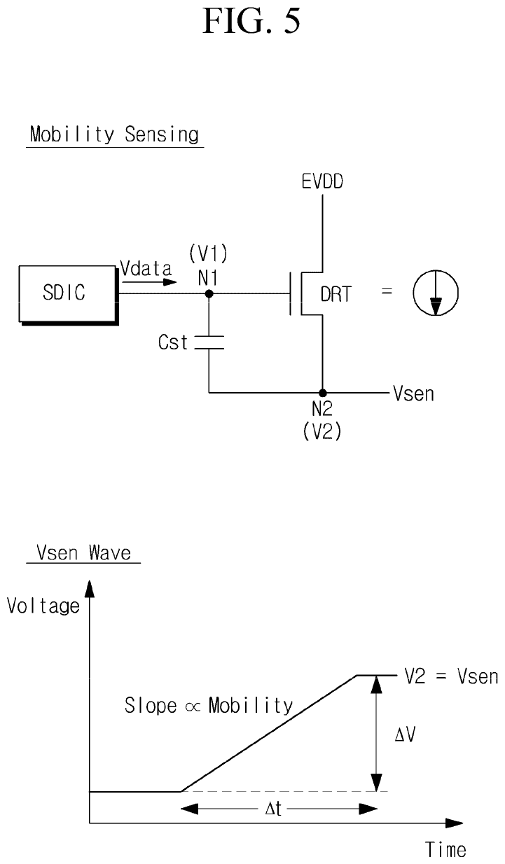

FIG. 5 is a diagram for explaining a method for sensing mobility of a driving transistor.

With reference to FIGS. 3 and 5, the mobility sensing operation for the driving transistor DRT may be performed through a sensing process an initialization stage, a tracking stage, and a sampling stage.

In the initialization stage, the initialization switch SPRE is turned on. Subsequently, the scan signal SCAN and the sensing signal SENSE may be applied to turn on the first transistor T1 and the second transistor T2. As a result, the first node N1 and the second node N2 are initialized respectively with the data voltage Vdata and the reference voltage Vref for mobility sensing (V1=Vdata, V2=Vref).

The tracking stage involves charging the voltage V2 of the second node N2 until it reaches a voltage state reflecting the mobility or the change in mobility. That is, the tracking stage involves tracking the voltage of the second node N2 corresponding to the mobility or the change in mobility. During this tracking stage, the initialization switch SPRE or the second transistor T2 may be turned off, causing the second node N2 to float. In this case, the first transistor T1 is turned off, causing the first node N1 to float. As a result, the voltage V2 of the second node N2 begins to rise.

The rate of voltage increase of the second node N2 depends on the current-carrying capacity (or mobility) of the driving transistor DRT. A driving transistor DRT with higher mobility leads to a steeper rise in the voltage V2 of the second node N2.

After a certain duration Δt of the tracking stage, i.e., after the voltage V2 of the second node N2 has risen for a predetermined time period Δt, the sampling stage may be initiated. During the tracking stage, the rate of voltage increase of the second node N2 corresponds to the voltage change ΔV over a predetermined duration At.

In the sampling stage, the sampling switch SAM may be turned on, establishing an electrical connection between the sensing unit 410 and the reference voltage line RVL.

Consequently, the sensing unit 410 senses the voltage V2 of the second node N2 through the reference voltage line RVL. The voltage Vsen sensed by the sensing unit 410 represents the voltage that has increased by the voltage change ΔV over the predetermined duration At from the initialization voltage Vref and corresponds to the mobility.

Through the threshold voltage or mobility sensing operation described with reference to FIGS. 4 and 5, the sensing unit 410 converts the sensed voltage (Vsen) sensed for the threshold voltage sensing or mobility sensing into a digital value and generates and output the sensing data including the converted digital value (sensing value). The sensing data outputted from the sensing unit 410 may be provided to the compensation unit 420. In some cases, the sensing data may also be provided to the compensation unit 420 through the memory 430.

The compensation unit 420 may check the characteristic values (e.g., threshold voltage or mobility) of the driving transistor DRT within the corresponding sub-pixel or the changes in characteristic values (e.g., change in threshold voltage or mobility) based on the sensing data provided by the sensing unit 410. Here, the changes in the characteristic values of the driving transistor DRT may refer to the change in the current sensing data compared to the previous sensing data or the change in the current sensing data compared to the initial compensation data.

By comparing the characteristic values or the changes in characteristic values of the driving transistor DRT, it is possible to determine the deviation in the characteristic values among the driving transistors DRT. When the changes in the characteristic values of the driving transistor DRT indicate the change in the current sensing data compared to the initial compensation data, it is also possible to determine the deviation of the characteristic values (i.e., sub-pixel luminance deviation) among the driving transistors DRT. Here, the initial compensation data may refer to the initial configuration data that is set and stored during the manufacturing of the display device.

The characteristic value compensation process may include a threshold voltage compensation process for compensating the threshold voltage of the driving transistor DRT and a mobility compensation process for compensating the mobility of the driving transistor DRT. The threshold voltage compensation process involves calculating compensation values for the threshold voltage or threshold voltage deviation (threshold voltage variation) and storing the calculated compensation values in the memory 430 or modifying the corresponding video data Data using the computed compensation values. The mobility compensation process involves calculating compensation values for the mobility or mobility deviation (mobility variation) and storing the calculated compensation values in the memory 430 or modifying the corresponding video data Data using the computed compensation values.

The compensation unit 420 may modify the image data Data through threshold voltage compensation or mobility compensation and supply the modified data to the corresponding source driver integrated circuit within the data driver 120. The source driver integrated circuit converts the modified data from the compensation unit 420 into a data voltage via a digital-to-analog converter and supplies the data voltage to the corresponding sub-pixel, allowing for compensation of the characteristic values (threshold voltage compensation and mobility compensation) of the sub-pixel.

Performing such sub-pixel characteristic value compensation may reduce or prevent luminance deviation between sub-pixels, thereby enhancing image quality.

The sensing unit 410 may sequentially sense the sub-pixels SP in units of pixel line. In an embodiment, when reference voltage line RVL is arranged per sub-pixel column, the sensing unit 410 may sequentially sense the sub-pixels SP in units of color on the same pixel line.

For example, when one pixel consists of four sub-pixels, such as red sub-pixel, white sub-pixel, green sub-pixel, and blue sub-pixel, the sensing unit 410 may sense the sub-pixels by color in a predetermined order on the same pixel line. For instance, the sensing unit 410 may sense the voltage V2 of the second node N2 of a plurality of red sub-pixels, which is applied through the reference voltage line RVL. Then the sensing unit 410 may sequentially sense the voltage V2 of the second node N2 of white sub-pixels, green sub-pixels, and blue sub-pixels, which is applied through the reference voltage line RVL.

However, when the reference voltage line RVL is arranged with four lines per sub-pixel column, corresponding to the number of sub-pixels constituting each pixel, the sensing unit 410 may sense the voltage V2 of the second node N2 for all sub-pixels driven by the gate lines GL controlled by the scan signal SCAN simultaneously. That is, the sensing unit 410 may perform multiple sensing operations for the voltage V2 of the second node N2 according to the number of reference voltage lines RVL corresponding to the number of sub-pixels constituting one pixel one gate line GL driven by the scan signal SCAN. Therefore, the compensation unit 420, which receives the sensing data from the sensing unit 410 and performs compensation value calculations, may also perform multiple compensation value calculations for one gate line GL.

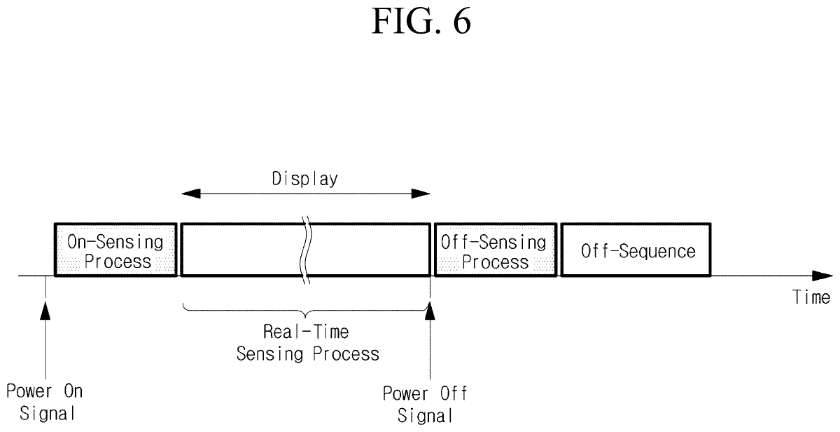

FIG. 6 is a diagram illustrating a sensing timing.

With reference to FIG. 6, when a power-on signal is generated, the display device 100 may sense the characteristic values of the driving transistor DRT within each pixel PX arranged on the display panel 110. This sensing process is referred to as the “on-sensing process.”

Additionally, when a power-off signal is generated, the display device 100 may sense the characteristic values of the driving transistors within each pixel PX arranged on the display panel 110 before the initiation of the off-sequence such as power shutdown. This sensing process is referred to as the “off-sensing process.”

It is also possible to sense the characteristic values of the driving transistor DR within each pixel PX arranged on the display panel 110 during every blank periods in the display operation from the generation of the power-on signal until the generation of the power-off signal. This real-time sensing process is referred to as “real-time sensing process.” The real-time sensing process may be carried out during the blank time between active periods, based on the vertical sync signal.

The mobility sensing of the driving transistor DRT may occur before the display driving starts, after the power-on signal is generated, or when the display driving does not occur after the power-off signal is generated. Additionally, the mobility sensing of the driving transistor DRT may also be carried out in real-time utilizing short blanking periods during display driving.

Compared to the mobility sensing of the driving transistor DRT, the threshold voltage sensing of the driving transistor DRT takes relatively longer time because it requires a long voltage saturation period of the second node N2. Hence, the threshold voltage sensing of the driving transistor DRT may be performed during the period when the power-off signal is generated and the display driving is not occurring, i.e., when the user is not actively viewing the display. However, in some cases, the threshold voltage sensing of the driving transistor DRT may also be performed as part of an on-sensing process or a real-time sensing process.

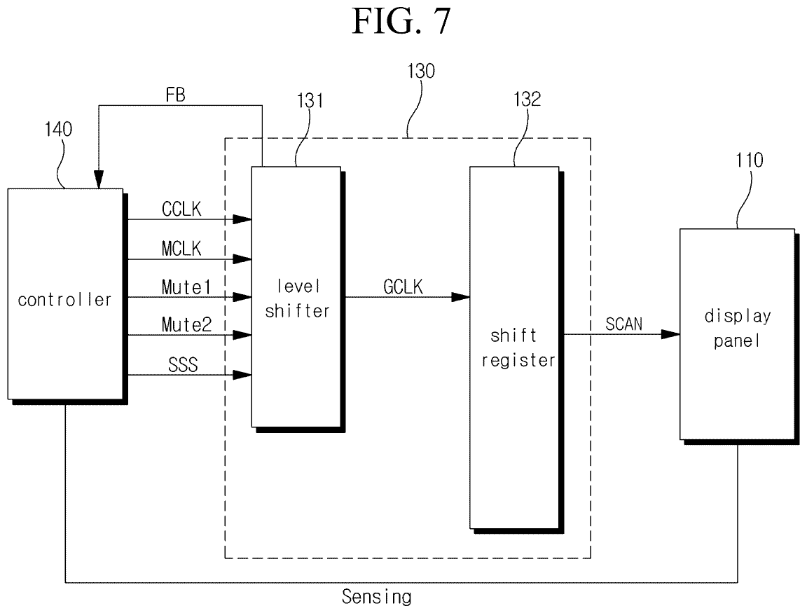

FIG. 7 is a block diagram illustrating a connection relationship between a controller and a gate driver.

With reference to FIG. 7, the controller 140 may output the first clock CCLK, the second clock MCLK, the line selection signal Mute1, the color selection signal Mute2, and the sensing start signal SSS.

The first clock CCLK is an on-clock that indicates the rising edge timing of the gate clock signal CCLK as mentioned later, and the second clock MCLK may be an off-clock that indicates the polling edge timing of the gate clock signal GCLK. To determine the output timing of the first clock CCLK and the second clock MCLK, the controller 140 may have an internal counter. The internal counter is configured to increment sequentially from an initial value by a predetermined count value.

The internal counter may utilize a reference clock with a predetermined frequency as the reference signal. For example, the reference signal may be a predetermined reference clock generated through an external host or an internal power circuit. One period of such reference clock may correspond to one horizontal period 1H.

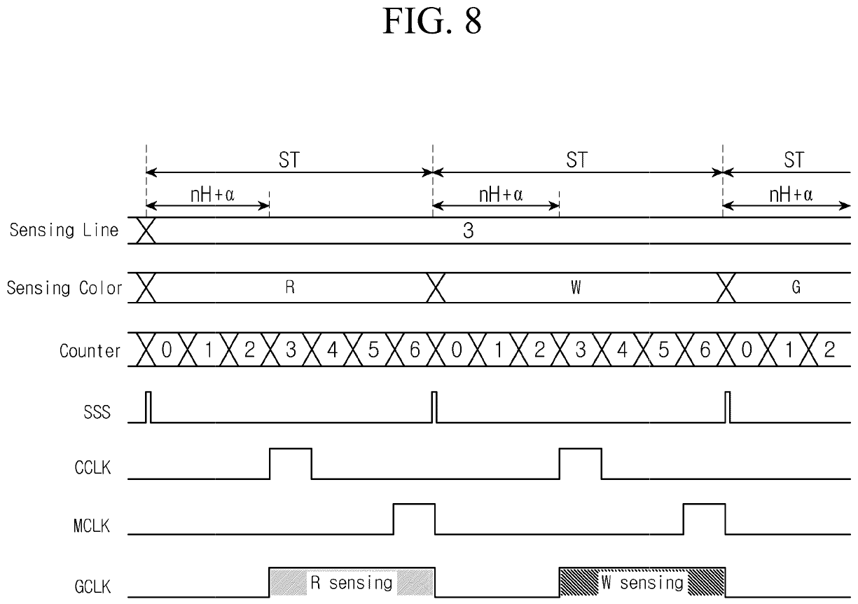

During one sensing period (ST in FIG. 8), the controller 140 may control to sense a selected sub-pixel SP. The selected sub-pixel SP may be a sub-pixel of a selected color according to a predetermined order within the selected sensing line.

When the sensing period ST, see FIG. 8, starts, the controller 140 counts the reference clock using the internal counter, and when the count of the reference clock reaches a predetermined first reference count value, i.e., the first horizontal period has elapsed, the controller 140 may output the first clock CCLK. Furthermore, when the count of the reference clock reaches a predetermined second reference count value, i.e., the second horizontal period has elapsed, the controller 140 may output the second clock MCLK.

The gate driver 130 may receive the first clock CCLK, the second clock MCLK, the line selection signal Mute1, the color selection signal Mute2, and the sensing start signal SSS from the controller 140, and it may include a level shifter 131 outputting the gate clock signal GCLK and a shift register 132 outputting the scan signal SCAN based on the gate clock signal GCLK. In an embodiment, the level shifter 131 may be formed as a separate independent component, not integrated within the gate driver 130, and it may be placed on the display panel 110.

The level shifter 131 may select a pixel line to be sensed (hereinafter, sensing line) and sub-pixel color based on the line selection signal Mute1 and color selection signal Mute2. In an embodiment, the level shifter 131 may be configured to select the sensing line and sensing color based on the output timing of the first clock CCLK and the second clock MCLK. That is, the output timing of the first clock CCLK and the second clock MCLK may be determined in correspondence with the sensing line.

The level shifter 131 may perform predetermined preparatory operations to sense the sub-pixels of the selected color within the selected sensing line. For example, the level shifter 131 may control the shift register 132 to control the output of the scan signal SCAN through connected stages of the selected sensing line (stage shifting). However, this embodiment is not limited thereto, and in alternative or additional embodiments, the stage shifting may be omitted when the sensing line is in a hold state. Once the sensing preparation is completed, the level shifter 131 may send a feedback signal FB to the controller 140.

Upon receiving the sensing start signal SSS from the controller 140, the level shifter 131 may determine that it has entered the sensing mode and output the generated gate clock signal GCLK. The level shifter 131 may generate the gate clock signal GCLK based on the first clock CCLK and the second clock MCLK.

In an embodiment, the gate clock signal GCLK may be a pulse signal with a determined turn-on length. The rising edge of the gate clock signal GCLK may be synchronized or aligned with the rising edge of the first clock CCLK, and the falling edge of the gate clock signal GCLK may be synchronized or aligned with the falling edge of the second clock MCLK. However, this embodiment is not limited thereto.

The shift register 132 may generate a scan signal SCAN based on the gate clock signal GCLK received from the level shifter 131 and output the generated scan signal SCAN to the display panel 110 through the gate lines GL. For example, the scan signal SCAN may be a pulse signal synchronized with the gate clock signal GCLK, and the turn-on level of the pulses in the scan signal SCAN may have the same duration as the turn-on level of pulses in the gate clock signal GCLK.

During the scanning of the sensing lines through the scan signal SCAN, the controller 140 may sense the characteristic values of the selected sub-pixels SP of the chosen color.

In an embodiment, the shift register 132 may be composed of a plurality of stages each connected to at least one gate line GL in a cascade configuration. Each stage is configured to output the scan signal SCAN through the connected gate line GL. When the sensing lines are selected through the level shifter 131, the shift register 132 may perform preparatory operations through the stages connected to the selected sensing lines to output the scan signal SCAN.

FIG. 8 is a timing diagram illustrating transmission and reception signals between a controller and a gate driver during an on-sensing process according to an embodiment.

With reference to FIG. 8, when power-on signal is generated, external power voltage may be applied, enabling activation of the controller 140 and internal power supply circuitry of the display device 100. The controller 140 may boot up and initialize internal components by loading firmware and pre-stored control parameters.

Once the booting process is complete, the display device 100 may perform sensing of the display panel 110. The controller 140 may apply drive voltage EVDD to the display panel 110 through the power supply circuit and perform an on-sensing process to sense the characteristic values of the driving transistor DRT within each sub-pixel SP of the display panel 110.

During the on-sensing process, the display device 100 may sequentially scan a plurality of pixel lines. The display device 100 may sequentially sense the characteristic values of the sub-pixels SP for the selected sensing lines. For example, during the on-sensing process, the display device 100 may sequentially sense the characteristic values of the sub-pixels SP for the first pixel line, followed by the second pixel line, and so on, sequentially scanning all the pixel lines to sense the characteristic values of the sub-pixels SP.

In an embodiment, when there is one reference voltage line RVL per pixel line and each pixel includes four color sub-pixels (red, white, green, blue sub pixels), sensing may be performed four times corresponding to the number of sub-pixels for a given pixel line as illustrated. In the illustrated embodiment, it shows an example where the second pixel line is sequentially sensed, e.g., starting with the red sub-pixel, followed by the white, green, and blue sub-pixels.

The controller 140 may count the reference clock using an internal counter during the sensing period ST for each color sub-pixel SP. In the illustrated example, to sense the second pixel line, the controller 140 may output the first clock CCLK when the reference clock reaches a count value of 3 and output the second clock MCLK when it reaches a count value of 6.

The level shifter 131 may output the gate clock signal GCLK corresponding to the first clock CCLK and the second clock MCLK. In the illustrated example, starting from the beginning of the sensing period ST of a sub-pixel SP, the gate clock signal GCLK may be synchronized with the first clock CCLK after a count value of 3, representing the turn-on level, and may be synchronized with the second clock MCLK after a count value of 6, representing the turn-off level (without output of the gate clock signal GCLK). In such an embodiment, the gate clock signal GCLK may be output as a pulse signal with a turn-on period of 3 count values, i.e., 3 horizontal periods.

In an embodiment, the controller 140 may reset the count value whenever completing the sensing of a certain sub-pixel SP. Resetting the count value may mean setting the initial value of the count as ‘0’. Subsequently, the controller 140 may perform a new count from the reset value to generate the first clock CCLK and the second clock MCLK.

In this embodiment, a predetermined count time may be required until the first clock CCLK is output. That is, until the first clock CCLK is output, it may take a time period (n horizontal periods (nH),) required for the reset count value to reach the first reference count value and a predetermined sensing preparation time (α, e.g., the time required for stage transitions). When the count time becomes longer, the sensing period ST also become longer, resulting in increase of the user response time until the image is displayed after power-on control.

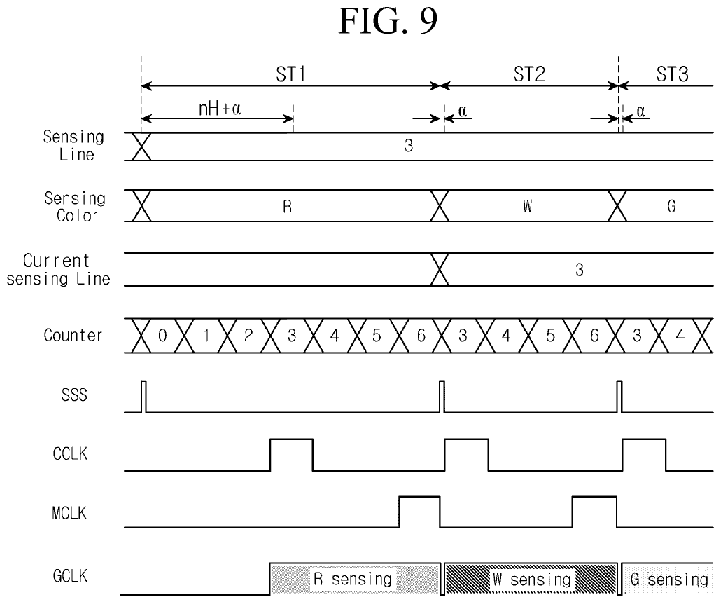

FIG. 9 is a timing diagram illustrating transmission and reception signals between a controller and a gate driver during an on-sensing process according to another embodiment.

With reference to FIG. 9, in another embodiment, the controller 140 may not initialize the counter when sensing the sub-pixels SP on the same sensing line. That is, when sequentially sensing different colors of sub-pixels SP within the same sensing line, the controller 140 may not reset the counter for each sub-pixel SP during the sensing period ST.

That is, during the first sensing period ST1, the controller 140 may store information about the current sensing line. This information about the current sensing line includes the line number of sensing line of the currently sensed sub-pixels SP. In an embodiment, the controller 140 may store the information about the current sensing line in a memory 430 or the like.

During the subsequent sensing period ST2, the controller 140 may determine whether the sub-pixel SP to be sensed belongs to the same pixel line as the previously stored pixel line, e.g., the pixel line that was immediately previously sensed. That is, the controller 140 evaluates whether the sub-pixel SP to be sensed is on the same pixel line as the previously sensed sub-pixels.

When the sub-pixel SP is not on the same pixel line as the immediate previous sub-pixels, the controller 140 may reset the counter as illustrated in FIG. 8. That is, when the controller 140 senses one pixel line and sequentially moves to the next pixel line, it may reset the count value. In this case, the controller 140 may generate the first clock signal (CCLK) and second clock signal (MCLK) in synchronization with the first reference counter value and the second reference counter value corresponding to the next pixel line.

Meanwhile, when the sub-pixel SP to be sensed is on the same pixel line as the immediately previously sensed sub-pixels, the controller 140 may not reset the counter. Instead, the controller 140 may set the initial value of the counter to the predetermined first reference count value (3 in the illustrated embodiment) in correspondence to the current sensing line, e.g., greater than the reset value of 0. As a result, the first clock signal (CCLK) may be immediately output at the beginning of the second sensing period ST2 in correspondence to the set first reference count value. The controller 140 may perform counting from the set count value and output the second clock signal MCLK when the count value reaches the predetermined second reference count value.

In response to the first clock signal CCLK and the second clock signal MCLK, the gate clock signal GCLK may be output. Since the first clock signal CCLK is output without count waiting, the gate clock signal GCLK may be output within a relatively short time when the sensing period ST starts, allowing the sensing of the selected sub-pixel SP to be performed.

The operation of the third sensing period ST3 may be similar to that of the second sensing period ST2. In detail, during the third sensing period ST3, the controller 140 may determine whether the sub-pixel SP to be sensed belongs to the same pixel line as the previously stored sub-pixels.

Since the sub-pixel SP to be sensed is on the same pixel line as the previously sensed sub-pixels, the controller 140 does not reset the counter. Instead, the controller 140 sets the initial value of the counter to the predetermined first reference count value (3 in the illustrated embodiment) in correspondence to the current sensing line, and thus the first clock signal CCLK may be immediately output in correspondence to the set first reference count value.

In this embodiment, when sub-pixels SP of the same sensing line are sensed, controller 140 may reduce the counting time required. This line sensing method effectively reduces the time required for the entire on-sensing process across all pixel lines. As a result, the display device 100 according to an embodiment is capable of reducing the user response time from power-on control to image display, thereby enhancing user convenience.

The display device and driving methods thereof according to the embodiments is capable of reducing the user response time from power-on control to the display of the image, thereby enhancing user convenience.

Although embodiments of this disclosure have been described above with reference to the accompanying drawings, it will be understood that the technical configuration of the this disclosure described above can be implemented in other specific forms by those skilled in the art without changing the technical concept or essential features of the present disclosure. Therefore, it should be understood that the embodiments described above are examples and not limited in all respects. In addition, it should be understood that all modifications or variations derived from the meaning and scope of the claims and their equivalent concept are included within the scope of the this disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a display panel comprising sub-pixels arranged thereon;
a gate driver configured to apply a scan signal to the sub-pixels; and
a controller configured to sense a characteristic value of the sub-pixels,
wherein the controller is configured to output a first clock and a second clock based on a count value that increases from an initial value during a sensing period for sensing a selected sub-pixel, and the gate driver is configured to generate a gate clock signal based on the first clock and the second clock and to generate the scan signal based on the gate clock signal.

2. The display device of claim 1, wherein the controller is configured to output the first clock in response to the count value reaching a first reference count value and to output the second clock in response to the count value reaching a second reference count value.

3. The display device of claim 2, wherein the controller is configured to generate the gate clock signal that has a rising edge aligned with a rising edge of the first clock and has a falling edge aligned with a falling edge of the second clock.

4. The display device of claim 2, wherein the controller is configured to sense the sub-pixels sequentially in units of a pixel line and in units of color on the pixel line.

5. The display device of claim 4, wherein the controller is configured to determine the initial value of the count value based on whether the selected sub-pixel is on a same pixel line as a previously sensed sub-pixel.

6. The display device of claim 5, wherein the controller sets the initial value of the count value to the first reference count value in response to the selected sub-pixel being on the same pixel line as the previously sensed sub-pixel.

7. The display device of claim 5, wherein the controller is configured to initialize the count value to obtain the initial value in response to the selected sub-pixels not being on the same pixel line as the previously sensed sub-pixel.

8. The display device of claim 4, wherein the controller comprises a memory configured to store information on a pixel line of the selected sub pixel.

9. The display device of claim 4, wherein the controller is configured to transmit a sensing start signal to the gate driver, and the gate driver is configured to output the gate clock signal in response to the sensing start signal.

10. The display device of claim 1, wherein the controller is configured to sense the characteristic value of the sub-pixels in response to a power-on signal.

11. A driving method of a display device including a display panel on which sub-pixels are arranged, a gate driver for applying a scan signal to the sub-pixels, and a controller for sensing a characteristic value of the sub-pixels, the method comprising:
increasing, by the controller, a count value from an initial value during a sensing period for sensing a selected sub-pixel;
outputting a first clock in response to the count value reaching a first reference count value;
outputting a second clock in response to the count value reaching a second reference count value greater than the first reference count value; and
generating, by the gate driver, a gate clock signal based on the first clock and the second clock.

12. The method of claim 11, further comprising:
determining, before the increasing the count value, whether the selected sub-pixel is on a same pixel line as a previously sensed sub-pixel; and
setting the initial value of the count value to the first reference count value in response to the selected sub-pixel being on the same pixel line as the previously sensed sub-pixel.

13. The method of claim 12, further comprising initializing the count value to obtain the initial value in response to the selected sub-pixel being not on the same pixel line as the previously sensed sub-pixel.

14. The method of claim 11, further comprising storing information on the pixel line of the selected sub-pixel.

15. The method of claim 11, wherein the sensing of the characteristic value of the sub-pixels is performed in response to a power-on signal.

16. A display device, comprising:
a display panel comprising sub-pixels arranged in pixel lines;
a controller configured to sense a characteristic of a driving transistor of a selected sub-pixel,
wherein:
the controller is configured to output a first clock and a second clock based on a count value that increases from an initial value during a sensing period for sensing the selected sub-pixel, and
the controller is configured to set the initial value of the count value differently based on whether the selected sub-pixel is on a same pixel line as an immediately previously sensed sub-pixel or on a different pixel line from that of an immediately previously sensed sub-pixel.

17. The display device of claim 16, further comprising a gate driver configured to output a scan signal for the selected sub-pixel based on the first clock signal and the second clock signal.

18. The display device of claim 16, wherein the controller is configured to output the first clock in response to the count value reaching a first reference count value and to output the second clock in response to the count value reaching a second reference count value that is greater than the first reference count value.

19. The display device of claim 18, wherein the controller is configured to set the initial value of the count value to the first reference count value in response to the selected sub-pixel being on the same pixel line as the immediately previously sensed sub-pixel, and the controller is configured to set the initial value to a value smaller than the first reference count value in response to the selected sub-pixel being on a different pixel line from that of the immediately previously sensed sub-pixel.

20. The display device of claim 16, wherein the controller is configured to set the initial value of the count value to a first value in response to the selected sub-pixel being on the same pixel line as the immediately previously sensed sub-pixel, and set the initial value to a second value smaller than the first value in response to the selected sub-pixel being on a different pixel line from that of the immediately previously sensed sub-pixel.
